(19) United States
(12) Patent Application Publication
(10) Pub. No.: US 2025/0038629 A1
(43) Pub. Date: Jan. 30, 2025

(54) METHOD FOR MANUFACTURING A ROTOR FOR AN ELECTRIC MACHINE

(71) Applicants: AMPERE S.A.S., Boulogne Billancourt (FR); WHYLOT, Cambes (FR)

(72) Inventors: Jere KOLEHMAINEN, CLEON (FR); Fernando BONILLA-ANGULO, Guyancourt (FR); Gildas LECUYER, CLEON (FR); Laurent AUBANEL, Guyancourt (FR)

(21) Appl. No.: 18/836,868

(22) PCT Filed: Feb. 9, 2023
(86) PCT No.: PCT/EP2023/053210

§ 371 Date: Aug. 8, 2024

(30) Foreign Application Priority Data
Feb. 11, 2022 (FR) FR2201220

(51) Int. Cl. H02K 15/03; H02K 1/278; H02K 1/28

(52) U.S. Cl. CPC H02K 15/03; H02K 1/278; H02K 1/28

(57) ABSTRACT

The invention relates to a method for manufacturing a rotor (1) for an electric machine comprising a body (10) and at least one magnet (20) which is carried by the body and which comprises at least one first unitary magnet (21) and at least one second unitary magnet (22), said method comprising the following steps:
forming the first unitary magnet by depositing a magnetic material over a support (30) distinct from the body;
fastening the support with respect to the body.

### TECHNICAL FIELD OF THE INVENTION

The present invention generally relates to electric machines.

More particularly, it relates to a method for manufacturing an electric machine rotor for a radial-flux or axial-flux electric machine.

It also relates to a rotor manufactured according to this method.

The invention finds a particularly advantageous application in electric motors for electric or hybrid motor vehicles.

### PRIOR ART

In general, an electric machine comprises a stator and a rotor. The rotor carries a series of large permanent magnets, whereas a series of coils is carried by the stator. When the coils are supplied with an electric current, the rotor, which is secured to the output shaft of the electric machine, is subjected to a torque resulting from the magnetic field.

It is known from the document “Novel Multi-layer Design and Additive Manufacturing Fabrication of a High Power Density and Efficiency Interior PM Motor, 2020 IEEE Energy Conversion Congress and Exposition (ECCE), 2020, pp. 3601-3606, M. Ibrahim, F. Bernier and J.-M. Lamarre”, rotors wherein the permanent magnets are formed by dynamic cold spraying, a method that is more known by the English name “cold spraying”. Spraying being carried out “at cold temperature”, typically between 100° C. and 200° C., it does not deform the body of the rotor. It also allows directly fastening the large permanent magnets onto the body of the rotor and thus avoids the need for an additional step of fastening the magnets. Finally, because of their formation by cold spraying over the body of the rotor, the magnets are securely fastened onto the latter.

Nonetheless, these large permanent magnets are subject to energy losses due to eddy currents flowing therethrough when the electric machine is operating, which limits the performances of the electric machine.

### DISCLOSURE OF THE INVENTION

In order to overcome the aforementioned drawback of the prior art, the present invention proposes segmenting these large permanent magnets into a plurality of unitary magnets while forming them by deposition of a magnetic material. Preferably, said material is also metallic.

More particularly, a method is provided according to the invention for manufacturing a rotor for an electric machine comprising a body and at least one magnet which is carried by the body and which comprises at least one first unitary magnet and at least one second unitary magnet, said method comprising the following steps:
forming the first unitary magnet by depositing a magnetic material over a support distinct from the body;
fastening the support to the body.

Thus, thanks the invention, the magnet is divided into several unitary magnets. The unitary magnets then form portions of the magnet which are more electrically-insulated from one another than their equivalent in the form of one single magnet made in one-piece. This allows reducing eddy currents within the magnet and therefore reducing energy losses. Thus, the performances of the electric machine are enhanced in comparison with the use of large permanent magnets made in one-piece of the prior art.

According to the invention, the deposition of a magnetic material, preferably also metallic, is an additive manufacturing process, i.e. a process by adding material, such as the cold spraying of a magnetic material, i.e. by dynamic cold spraying, or magnetic printing, more known as 3D printing.

In a counter-intuitive manner, the invention therefore proposes making unitary magnets by depositing a magnetic material over a support distinct from the body of the rotor. Indeed, although the magnets are not formed directly over the body and fastening thereof is thus less resistant to mechanical stresses and more complex than in the prior art, this allows dividing the magnet into unitary magnets and reducing eddy currents.

In other words, the increase in the energy performances of the rotor manufactured according to the method in accordance with the invention is favoured.

Other advantageous and non-limiting features of the method for manufacturing a rotor for an electric machine in accordance with the invention, considered individually or according to any technically-feasible combination, are as follows:
the first unitary magnet is formed by cold spraying of a magnetic material;
the fastening step comprises positioning a face of the first unitary magnet opposite and at a distance of less than 1 mm from a face of the second unitary magnet;
the method comprises a step of forming the second unitary magnet by depositing a magnetic material over the body;
the body comprises a stack of metal laminations and wherein the second unitary magnet is formed by depositing a magnetic material over at least two of said metal laminations;
said at least one second unitary magnet has a shape complementary to that of said at least one first unitary magnet and the fastening step comprises nesting said at least one first unitary magnet with said at least one second unitary magnet;
the support is made of a magnetically-conductive material and, in the step of fastening the support, it is provided to position the support at the periphery of the rotor;
the first unitary magnet is formed over an inner surface of the support and a step of forming the second unitary magnet is provided for by depositing a magnetic material over an outer surface of the support opposite to the inner surface;
said support is made of an electrically-insulating material;
the body comprises at least one recess and, in the step of fastening the support, it is provided to insert the support into said recess.

The invention also proposes a rotor for an electric machine comprising:
a body;
at least one magnet which is carried by the body; and
a support distinct from the body and affixed on the body;
said magnet comprising at least:
a first unitary magnet which is formed by depositing a magnetic material over the support; and a second unitary magnet.

Of course, the different features, variants and embodiments of the invention could be associated together according to various combinations to the extent that they are not incompatible or exclusive of each other.

### DETAILED DESCRIPTION OF THE INVENTION

The following description with reference to the appended drawings, given as non-limiting examples, will clearly explain what the invention consists of and how it could be carried out.

In the appended drawings:

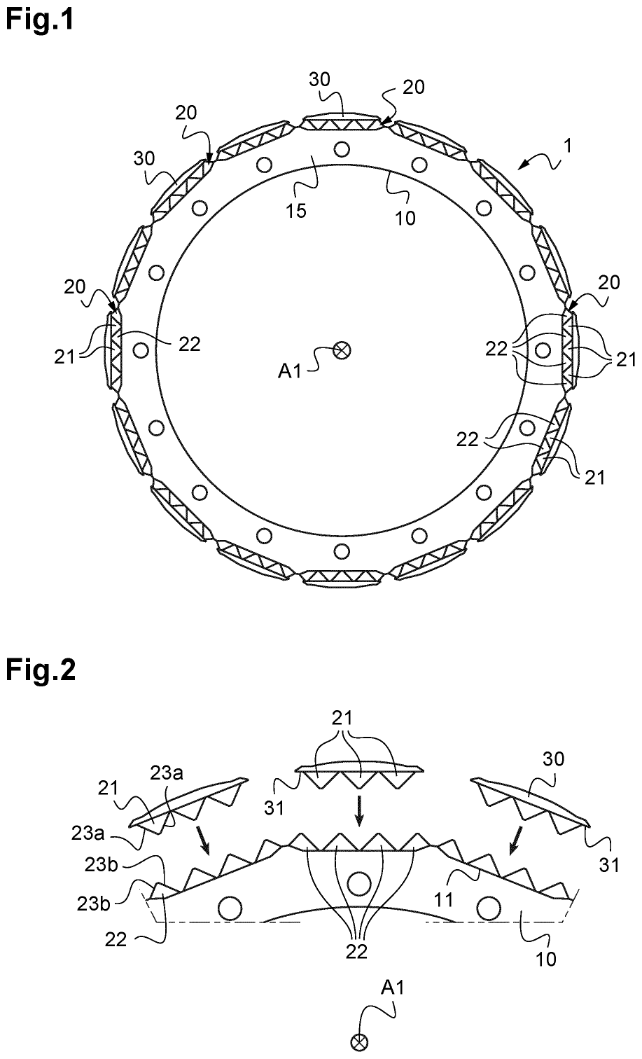

FIG. 1 is a schematic sectional view of a rotor in accordance with a first embodiment, obtained by means of a manufacturing method in accordance with the invention;

FIG. 2 is a schematic sectional view of a portion of the rotor of FIG. 1 before fastening supports onto the body of the rotor;

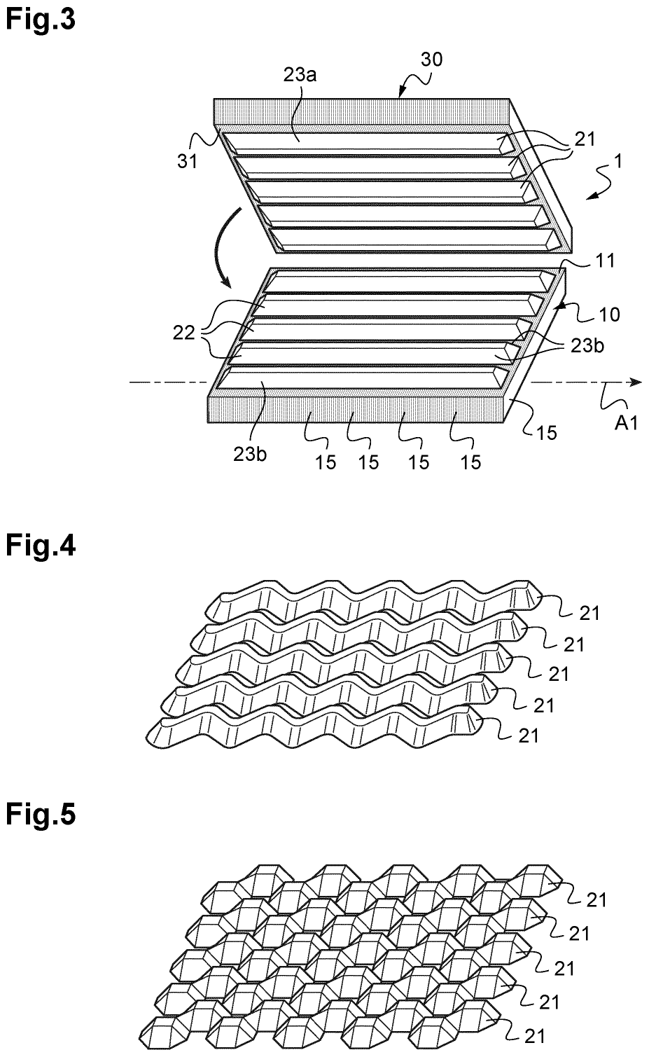

FIG. 3 is a schematic perspective view of a portion of the rotor of FIG. 1 before fastening supports onto the body of the rotor;

FIG. 4 is a schematic perspective view of an example of unitary magnets implemented in a first variant of the first embodiment of the rotor;

FIG. 5 is a schematic perspective view of another variant of unitary magnets implemented in the first embodiment;

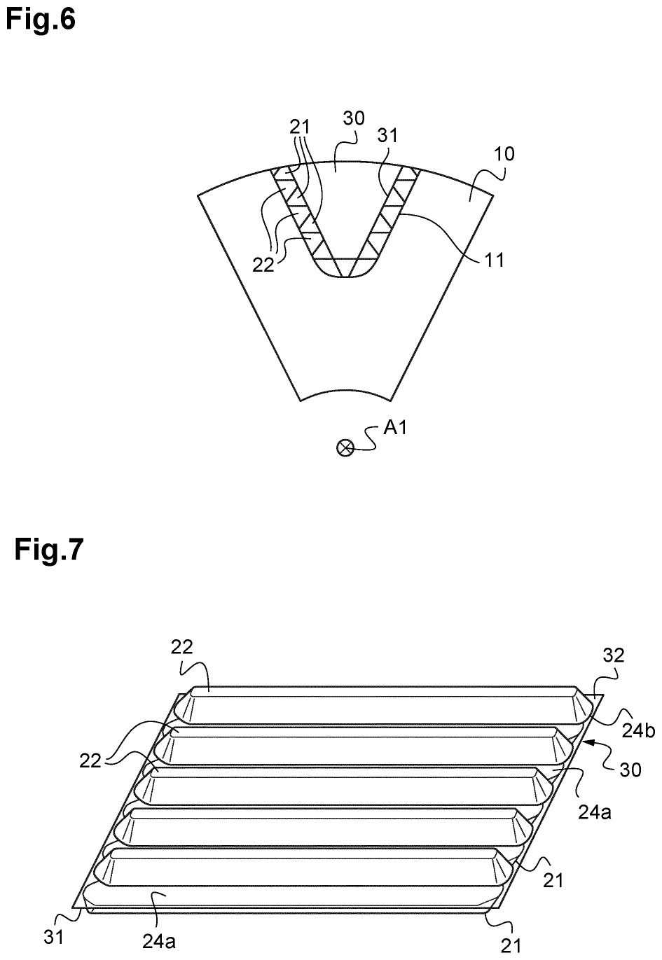

FIG. 6 is a schematic sectional view of a portion of another example of a rotor in accordance with the first embodiment, obtained by means of a manufacturing method in accordance with the invention;

FIG. 7 is a schematic perspective view of a support over which unitary magnets are deposited for manufacturing a rotor in accordance with a second embodiment, obtained by means of a manufacturing method in accordance with the invention;

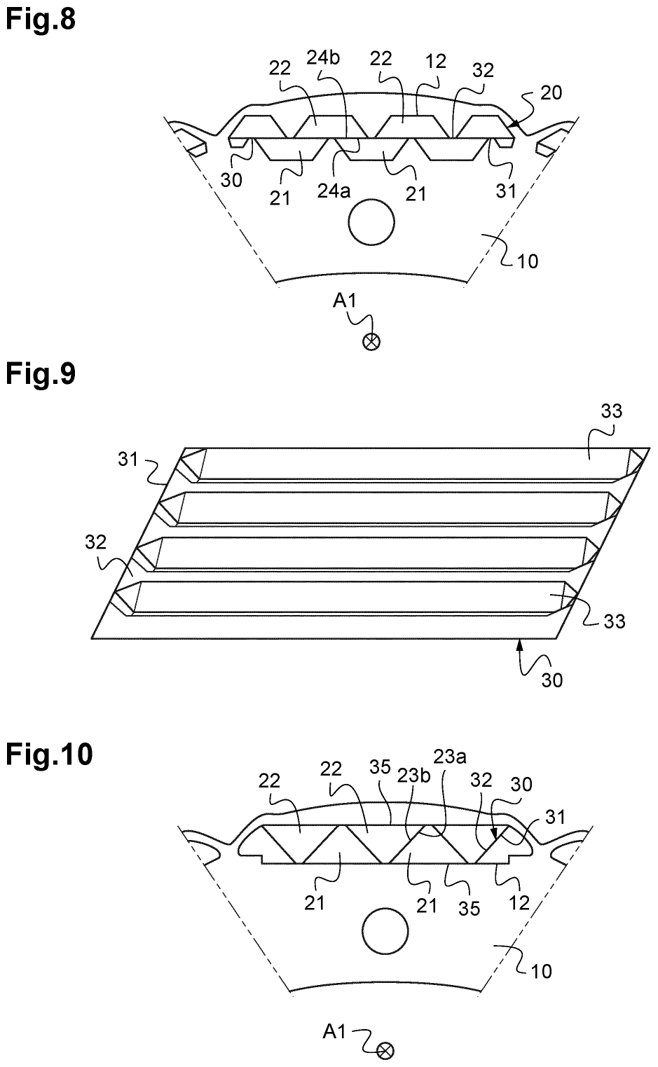

FIG. 8 is a schematic sectional view of a portion of a rotor in accordance with the second embodiment and comprising the support and the unitary magnets of FIG. 7;

FIG. 9 is a schematic perspective view of another variant of the support for manufacturing a rotor in accordance with the second embodiment;

FIG. 10 is a schematic sectional view of a portion of another example of a rotor in accordance with the second embodiment and comprising the support of FIG. 9.

First of all, It should be noted that identical or similar elements of the different embodiments of the invention shown in the figures will be, to the extent possible, referenced by the same reference signs and they will not be described each time.

FIG. 1 shows a rotor 1 for an electric machine obtained by means of a manufacturing method in accordance with the invention.

This rotor 1 is herein intended to form part of a radial-flux electric machine, this machine being in this case a motor for propelling an electric or hybrid vehicle. Such a machine comprises a rotor and a stator. The invention is particularly suited for the manufacture of an electric machine having an extended range of rotational speed values.

As shown in FIG. 1, the rotor 1 comprises a body 10, whose shape is generally tubular around an axis of rotation A1, and permanent magnets, hereinafter so-called magnets 20. The body 10 is herein made of a ferromagnetic material such as electrical steel.

In turn, the stator (not shown) also has a tubular shape and surrounds the rotor 1. In practice, the stator and the rotor 1 are co-axially aligned around the axis of rotation A1. Over its internal face directed towards the rotor 1, the stator comprises teeth around which coils of an electrically-conductive wire are wound. For indication, the stator is also compatible with a hairpin winding (“hairpin winding” in English). When these windings are supplied with an electric current, they generate a rotating magnetic field driving in particular the permanent magnets, which allows setting the rotor 1 in movement.

More specifically, the invention relates to the rotor 1.

As shown in FIG. 3, the body 10 of the rotor 1 is formed by a stack of metal laminations 15, for example electrical steel, extending perpendicularly to the axis of rotation A1. Thus, for example, the section of the body 1 shown in FIG. 1 comprises one single metal lamination 15. Alternatively, the body may be made by compacting a magnetic powder.

The rotor 1 also comprises a plurality of supports 30. More specifically, the rotor 1 comprises a support 30 for each magnet 20, i.e. herein sixteen supports 30 and magnets 20. Each support 30 is a part distinct from the body 10 meaning that the material forming the body 10, i.e. herein the metal laminations 15, does not form the supports 30. As explained later on, this is reflected herein by the fact that the supports 30 are manufactured separately from the body 10 and then affixed on the latter.

As shown in FIG. 1, each magnet 20 comprises a plurality of unitary magnets, i.e. at least two unitary magnets. In the example illustrated in FIG. 1, each magnet 20 comprises seven unitary magnets. Each unitary magnet is made in one-piece. By “unitary”, it should be understood herein that the unitary magnets are the smallest one-piece magnetic elements ma king up the magnets 20.

The unitary magnets forming the same magnet 20 are arranged side-by-side. Two unitary magnets forming the same magnet 20 arranged side-by-side are adjacent in the sense that they are located at a very small distance, with regards to their respective size, from each other. Typically, two adjacent unitary magnets are located at less than 1 mm from each other.

As shown in FIG. 1, each magnet 20 comprises more specifically first unitary magnets 21 and second unitary magnets 22. As shown in FIG. 2, the first unitary magnets 21 are separated from one another. The same applies to the second unitary magnets 22. This allows further reducing eddy currents within the magnet 20.

The rotor 1 is manufactured according to a method comprising the following main steps:
forming the first unitary magnets 21 by depositing a magnetic material over the supports 30;
fastening the supports 30 to the body 10 or onto the body 10.

By “formation”, it should be understood herein a process by which an object, in particular herein the first unitary magnets 21, acquires its shape. Thus, in this case, the deposition of the magnetic material confers their shape on the first unitary magnets 21 and that being so directly over the supports 30.

Preferably, the magnetic material is also metallic. More particularly, this method comprises a first step of providing or manufacturing the body 10. In this case, the first step comprises cutting the metal laminations 15 to the desired shape, for example the shape shown in FIG. 1, and stacking and fastening the metal laminations to form the body 10.

Afterwards, the method comprises a second step of providing or manufacturing the supports 30.

A third step of the method comprises forming the first unitary magnets 21 over the supports 30.

During the third step, the first unitary magnets 21 are formed by depositing a magnetic material, preferably also metallic. By “magnetic” material, it should be understood herein a material that could be magnetised so that it generates a permanent magnetic field or a material that already has a permanent magnetic field, examples are given hereinafter. Thus, the first unitary magnets 21 are formed by additive manufacturing, in contrast with a subtractive manufacturing (such as machining). In this case, the first unitary magnets 21 are more particularly formed by cold dynamic spraying of a magnetic material, hereinafter so-called “cold spraying”. Cold spraying is a process that is best known by the English name “cold spray”. It consists in spraying a magnetic powder, preferably also metallic, at a supersonic speed via a pressurised and heated gas. Thus, the first unitary magnets 25 are, by construction, securely fastened to the supports 30.

For example, the sprayed magnetic powder is a mixture of two powders: a first magnetic powder having a remanence higher than 700 mT which may be an alloy comprising neodymium, praseodymium, iron or boron, and a second magnetic powder, for example aluminium or copper. As regards the second powder, the use of powders of aluminium alloys, or of copper alloys, of ferrous alloys or of polymer powders is also possible. For example, the mixing ratio between the first powder and the second powder is comprised between 1:2 and 9:10. Preferably, the grain size of the first and second powders is comprised between 5 μm and 40 μm to enable effective spraying.

A fourth step of the method comprises forming the second unitary magnets 22. The second unitary magnets 22 may be formed over the body 10 (first embodiment illustrated in FIG. 1) or over the supports 30 (second embodiment illustrated in the FIG. 7).

During this fourth step, the second unitary magnets 22 are also formed by depositing a magnetic material and more particularly by cold spraying.

Alternatively, the unitary magnets may be formed by other additive manufacturing processes such as 3D printing of a magnetic material, for example by depositing a magnetic powder and by locally melting it by means of a laser beam.

Finally, the method comprises a fifth step of fastening the supports 30 to the body 10. The fifth step allows fixing the position of the supports 30 and of the magnets 20 with respect to the body 10 in accordance with their final position in the electric machine.

The first embodiment of the method for manufacturing the rotor 1 according to the invention is shown in FIGS. 1 to 6.

This first embodiment is characterised in that, during the fourth step, the second unitary magnets 22 are formed directly over the body 10. This herein means that the second unitary magnets 22 are deposited by cold spraying over the metal laminations 15 of the body 10. Thus, the second unitary magnets 22 are securely fastened to the body 10.

In a remarkable manner, each of the second unitary magnets 22 extends over at least two metal laminations 15 of the body 10, which improves the cohesion of the metal laminations 15. Preferably, as schematised in FIG. 3, the second unitary magnets 22 extend over a large number of metal laminations 15, for example over 10 to 100 metal laminations 15.

In this first embodiment, the supports 30 too are preferably formed by a stack, according to the axis of rotation A1, of metal laminations which are for example made of the same material as that of the body 10. For each support 30, the first unitary magnets then extend over several metal laminations, which improves cohesion thereof.

Thus, the supports 30 are made of an electrically-conductive material and, as shown in FIG. 1, they are positioned at the periphery of the rotor 1. Thus, the supports 30 contribute to the conduction and channelling of magnetic fluxes in the rotor 1.

More specifically, the supports 30 are distributed, herein evenly, circumferentially all around the body 10 and at a distance from one another.

As shown in FIG. 3, the first unitary magnets 21 rise from an inner surface 31 of the support 10, the inner surface 31 being intended to be directed towards the body 10 of the rotor 1.

The second unitary magnets 22 rise from a peripheral surface 11 of the body 10. Each peripheral surface 11 of the body 10 is intended to be located opposite one of the supports 30.

In this first embodiment, for each magnet 20, the second unitary magnets 22 have more specifically a shape complementary to that of the first unitary magnets 21 so as to be nested as illustrated in FIG. 1. Thus, the first unitary magnets 21 form reliefs over the inner surfaces 31 and the second unitary magnets 22 form reliefs, with a shape complementary to that of the reliefs formed by the first unitary magnets 21, over the peripheral surfaces 11.

Preferably, for each magnet 20, the first unitary magnets 21 and the second unitary magnets 22 are more specifically designed so as to form a tight nesting, i.e. with very little free space therebetween, which allows maximising the volume of magnetic material. As detailed later on, this free space is advantageously filled with an electrically-insulating material.

Alternatively, the first and second unitary magnets may be nested so as to form channels which could be used to cool the rotor.

To achieve this tight nesting, the first unitary magnets 21 and the second unitary magnets 22 herein have similar shapes, as is the case in the examples illustrated in FIGS. 3 to 5. In addition, the first unitary magnets 21 are evenly spaced over the inner faces 31 and the second unitary magnets 22 are evenly spaced similarly, i.e. with the same spacing, over the peripheral faces 11. It should be noted that the unitary magnets 21, 22 positioned at the boundary of the magnets 20 may, by exception, have different shapes. As shown in FIGS. 2 and 3, the first unitary magnets 21 and the second unitary magnets 22 are then nested by shifting them by a half-spacing.

In the example illustrated in FIG. 3, each unitary magnet 21, 22 forms a rectilinear rib extending parallel to the axis of rotation A1. This ensures effective holding of the metal laminations. The section of a unitary magnet 21, 22 in a plane perpendicular to the axis of rotation A1 is generally triangular. More specifically, this section has an isosceles trapezoid shape. The top of this section, i.e. its shortest side, coming into contact with a peripheral surface 11 of the body 10 or the inner surface 31 of a support 30.

As shown in FIGS. 2 and 3, the unitary magnets 21, 22 have two main faces 23a, 23b rising from the body 10 or from a support 30. Once the rotor 1 has been assembled, each first unitary magnet 21 then has one of its main faces 23a which extends opposite and at a distance of less than 1 mm from the main face 23b of an adjacent second unitary magnet 22. The main faces 23a, 23b of two adjacent unitary magnets 21, 22 extend parallel to one another.

FIGS. 4 and 5 illustrate other variants of the unitary magnets 21, 22. In the example illustrated in FIG. 4, the unitary magnets 21 extend lengthwise in a corrugated, or sinusoidal, manner. In particular, this limits eddy currents which might circulate between two second unitary magnets 22 via the metal laminations 15. This is also valid for the first unitary magnets 21 with respect to the metal laminations forming the supports 30. Alternatively, the unitary magnets may extend in a sawtooth-like fashion and have planar faces.

In the example illustrated in FIG. 5, the unitary magnets 21, 22 have a more complex shape of a pad with planar faces which are connected to one another by thin walls. This shape limits eddy currents further in comparison with the other examples described hereinabove.

In this first embodiment, the second step comprises manufacturing the supports 30 by cutting and stacking metal laminations.

During the third step, the first unitary magnets 21 are formed over the inner surfaces 31 of the supports 30. The formation of unitary magnets 21 of the same shape and evenly spaced apart simplifies the cold spray process.

During the fourth step, the second unitary magnets 22 are formed over the peripheral surfaces 11 of the body 10. The fact that the second unitary magnets 22 have a shape similar to the first unitary magnets 21 simplifies the cold spray process.

The fifth step comprises nesting the first unitary magnets 21 with the second unitary magnets 22. Hence, the fifth step comprises positioning the main faces 23a, 23b of two adjacent unitary magnets 21, 22 opposite one another.

In the example illustrated in FIGS. 1 and 2, the inner surfaces 31 of the supports 30 and the peripheral surfaces 11 of the body 10 (over which the unitary magnets are formed) are generally planar. As shown by the arrows in FIG. 2, nesting could therefore be performed through a rectilinear translational movement of the supports 30 according to radial directions, i.e. perpendicular to the axis of rotation A1. A wide variety of shapes is then possible for the unitary magnets 21, 21, as shown in FIGS. 3 to 5. Nesting may also comprise a rotational movement as schematised by an arrow in FIG. 3.

In the example illustrated in FIG. 6, the inner surface 31 of each support 30 and the peripheral surfaces 11 of the body 10 have V-shaped curved shapes. Thus, the supports 30 have a generally triangular section in a plane perpendicular to the axis of rotation A1 (corresponding to the plane of FIG. 6). It is then provided for the unitary magnets 21, 22 also extending lengthwise according to the axis of rotation A1 and in a rectilinear manner (like in FIG. 3). Positioning the supports 30 then comprises a translational movement according to the axis of rotation A1 relative to the body 10 of the rotor 1. In this configuration, the second unitary magnets 22 radially block the first unitary magnets 21 and therefore form means, for the supports 30, resist radial stresses (typically centrifugal forces) when the rotor 1 is rotating. Hence, the rotor 1 according to the example illustrated in FIG. 6 is particularly resistant to mechanical stresses.

Referring to FIG. 2, an intermediate element of the manufacture of the rotor 1 according to the first embodiment is described herein: the “second unitary magnets-support” assemblies consisting of a support and second unitary magnets which are deposited over the latter in the fourth step.

Afterwards, the fifth step comprises fastening the second unitary magnets-support assemblies to the body 10. In this first embodiment, the supports 30 are thus fastened to the bodies 10 via the unitary magnets 21, 22.

In this case, the second unitary magnets-support assemblies are bonded to the body 10. For this purpose, the fifth step comprises depositing a glue over the first unitary magnets 21 and/or the second unitary magnets 22 before nesting thereof. For example, the glue is deposited over the main faces 23a, 23b of the unitary magnets 21, 22. For example, the glue is an epoxy resin, a two-component glue or a thermosetting glue. Preferably, the glue is electrically-insulating.

Alternatively, the second unitary magnets-support assemblies may be fastened to the body by an adhesive tape, screws or external fastening means such as hoops circumferentially surrounding the supports. In this variant, an electrical insulator is placed between the first and second unitary magnets.

Thus, advantageously, in this first embodiment, the unitary magnets 21, 22 of each magnet 20 are therefore separated from one another by a layer of an electrically-insulating material, herein a layer of glue. This layer of insulating material allows reducing eddy currents further in comparison with unitary magnets that would be in contact.

Advantageously, nesting of the first unitary magnets 21 with the second unitary magnets 22 offers considerable bonding surfaces which allows securely fastening the supports 30 to the body 10. The unitary magnets 21, 22 in form of pads as illustrated in FIG. 5 offer a larger bonding area than rectilinear unitary magnets 21, 22. Thanks to this large bonding surface, the rotor 1 according to the first embodiment is very resistant to mechanical stresses, in particular to radial stresses.

A second embodiment of the method for manufacturing the rotor 1 according to the invention is shown in FIGS. 7 to 10.

This second embodiment is characterised in that, during the fourth step, the second unitary magnets 22 are also formed over the supports 30. This means that the magnets 20 are integrally formed over the supports 30 and then affixed onto the body 10. As shown in FIGS. 8 and 10, the body 10 herein comprises recesses 12 in which it is provided to insert the magnets 20.

As shown in FIG. 7, each support 30 has a thin sheet shape. Preferably, the thickness of the supports 30 is less than 1 mm, it is for example equal to 0.2 mm. Thus, the supports 30 have two opposite surfaces: one is the inner surface 31, the other one is so-called the outer surface 32.

Referring to FIG. 7, an intermediate element of the manufacture of the rotor 1 according to the second embodiment is described herein: the “magnet-support” assembly consisting of a support and second unitary magnets which are deposited over the latter in the third step and in the fourth step.

In this second embodiment, the second unitary magnets 22 are formed over the outer surface 32 of the supports 30. In turn, the first unitary magnets 21 are formed over the inner surface 31 of the supports 30.

Preferably, the supports 30 are made of an electrically-insulating material, i.e. which does not conduct, or barely conducts, electric currents. For example, the supports 30 are made of ceramic, for example a ceramic comprising aluminium oxide, glass, stone or concrete.

Thus, the first unitary magnets 21 are particularly well electrically-insulated from the second unitary magnets 22, which allows effectively reducing eddy currents within the magnets 20, more than in the first embodiment.

An example of a rotor 1 according to the second embodiment is illustrated in FIGS. 7 and 8. As shown in FIG. 7, in this example, each support 30 is a plate. To simplify reading of FIG. 7, the support 30 is shown in transparency.

In this example, on each support 30, the unitary magnets 21, 22 form reliefs separated from one another and rising from each of the opposing surfaces of the support 30. More particularly, the unitary magnets 21, 22 form rectilinear ribs extending parallel to the axis of rotation A1, which subsequently enables the insertion of the magnet-support assembly into a recess 12 according to the axis of rotation A1. The section of a unitary magnet 21 in a plane perpendicular to the axis of rotation A1 herein has an isosceles trapezoid shape, except for its ends which are rounded.

In this example, on each support 30, the base 24a, 24b of the unitary magnets 21, 22, i.e. their contact surface with the support 30, extends opposite and at a distance of less than 1 mm from one or two other base(s) 24a, 24b.

In the case where the supports 30 are planar, and therefore the unitary magnets 21, 22 form reliefs, it is provided for the recesses 12 also having reliefs with a shape complementary to that of the unitary magnets 21, 22. Thus, for example, the recess 12 illustrated in FIG. 8 has a section in a plane perpendicular to the axis of rotation A1 whose shape is corrugated. Preferably, the magnet-support assembly is inserted into its recess 12 with some clearance, as illustrated in FIG. 8.

Another example of a rotor 1 according to the second embodiment is illustrated in FIGS. 9 and 10. As shown in FIG. 9 (where only the support 30 is shown), in this example, each support 30 is a plate having filling reliefs 33. The filling reliefs 33 form indentations in each of the opposite surfaces of the support 30. In this case, the filling reliefs 33 of the same surface of the support 30 are identical and evenly spaced. They herein form an alternation of hollows and bumps.

As shown in FIG. 10, on each support 30, the unitary magnets 21, 22 are formed in the filling reliefs 33. Thus, the magnets 20 are similar to those of the first embodiment illustrated in FIG. 1. Hence, each first unitary magnet 21 has one of its main faces 23a which extends opposite and at a distance of less than 1 mm from the main face 23b of an adjacent unitary magnet 21. Nonetheless, in this second embodiment, the insulating material separating the unitary magnets 21 from the same magnet 20 is the support 30 itself (and not the layer of glue).

The filling reliefs 33 may have other shapes, for example shapes adapted to manufacture the unitary magnets 21, 22 as shown in FIG. 4 or 5.

In all these examples where the supports 30 have filling reliefs 33, the magnet-support assemblies and the recesses 12 preferably have two planar main faces 35 as shown in FIG. 10.

In this second embodiment, the first step of the method for manufacturing the rotor 1 also comprises manufacturing the body 10 by cutting and stacking metal laminations 15. The metal laminations 15 are cut so as to form the recesses 12. In this case, the metal laminations are cut and placed identically with respect to one another. Thus, the recesses 12 form channels with a uniform section extending according to the axis of rotation A1.

The second step comprises providing or manufacturing the supports 30.

In this second embodiment, during the third step, the first unitary magnets 21 are formed over the inner surfaces 31 of the supports 30. The first unitary magnets 21 may be formed by rising from the planar inner surfaces 31, like in FIGS. 7 and 8, or by filling the filling reliefs 33, like in FIGS. 9 and 10.

Similarly, during the fourth step, the second unitary magnets 22 are formed over the outer surfaces 32 of the supports 30. The second unitary magnets 21 may be formed by rising from the planar outer surfaces 32, like in FIGS. 7 and 8, or by filling the filling reliefs 33, like in FIGS. 9 and 10.

It should be noted herein that the concept of positioning amounts to forming the second unitary magnets 22. Thus, the fourth step comprises, for each first unitary magnet 21, positioning a face of a second unitary magnet 22 opposite one of the faces of the first unitary magnet 21. The opposing faces of two adjacent unitary magnets 21, 22 could be the main faces 23a, 23b (FIGS. 9 and 10) or the bases 24a, 24b (FIGS. 7 and 8).

The fifth step comprises positioning, herein by insertion, the magnet-support assemblies in the recesses 12.

Preferably, before insertion, glue is arranged over the magnet-support assemblies. Thus, once inserted and once the glue has solidified, the magnet-support assemblies are fastened in the recesses 12. In this second embodiment, the supports 30 are thus fastened to the body 10 via the unitary magnets 21, 22.

Alternatively, it may be provided to fasten the magnet-support assembly by other means such as force-fitting, screws or holding parts obstructing the recesses.

The present invention is in no way limited to the described and illustrated embodiments, yet a person skilled in the art should know how to make any variant in accordance with the invention.

Thus, the two embodiments that have been described could be combined. For example, it is possible to use a ceramic plate on which the unitary magnets are deposited over on surface, and then bond the opposite surface of the plate onto the body and onto unitary magnets that have been deposited over the body.

The unitary magnets may also extend according to directions other than that of the axis of rotation, for example according to orthoradial directions, i.e. orthogonal to the axis of rotation and to a radial direction.

It is also possible to provide for the rotor comprising several layers of magnets manufactured according to the invention stacked radially. In particular, this allows making a permanent magnet assisted synchronous reluctance motor. For example, such a rotor may be manufactured by nesting several V-shaped supports, adapted to that one shown in FIG. 6, inside one another.

Finally, although the figures illustrate only the invention in the context of a rotor for a radial-flux electric machine, the invention in its most general formulation is completely suited to the manufacture of a rotor for an axial-flux electric machine.

1. A method for manufacturing a rotor for an electric machine comprising a body and at least one magnet which is carried by the body and which comprises at least one first unitary magnet and at least one second unitary magnet, said method comprising the following steps:
forming the first unitary magnet by depositing a magnetic material over a support distinct from the body;
fastening the support to the body.

2. The method for manufacturing a rotor according to claim 1,
wherein the first unitary magnet is formed by cold spraying of a magnetic material.

3. The method for manufacturing a rotor according to claim 1, wherein the fastening step comprises positioning a face of the first unitary magnet opposite and at a distance of less than 1 mm from a face of the second unitary magnet.

4. The method for manufacturing a rotor according to claim 1, comprising a step of forming the second unitary magnet by depositing a magnetic material over the body.

5. The method of manufacturing a rotor according to claim 4, wherein the body comprises a stack of metal laminations and wherein the second unitary magnet is formed by depositing a magnetic material over at least two of said metal laminations.

6. The method for manufacturing a rotor according to claim 4, wherein said at least one second unitary magnet has a shape complementary to that of said at least one first unitary magnet and wherein the fastening step comprises nesting said at least one first unitary magnet with said at least one second unitary magnet.

7. The method for manufacturing a rotor according to claim 4, wherein the support is made of a magnetically-conductive material and wherein, in the step of fastening the support, it is provided to position the support at the periphery of the rotor.

8. The method of manufacturing a rotor according to claim 1, wherein the first unitary magnet is formed over an inner surface of the support and wherein a step of forming the second unitary magnet is provided for by depositing a magnetic material over an outer surface of the support opposite to the inner surface.

9. The method for manufacturing a rotor according to claim 8, wherein said support is made of an electrically-insulating material.

10. The method for manufacturing a rotor according to claim 8, wherein the body comprises at least one recess and wherein, in the step of fastening the support, it is provided to insert the support into said recess.

11. A rotor for an electric machine comprising:
a body;
at least one magnet which is carried by the body; and
a support distinct from the body and affixed on the body;
wherein said magnet comprises at least:
a first unitary magnet which is formed by depositing a magnetic material over the support; and
a second unitary magnet.
